(19) United States
(12) Patent Application Publication
(10) Pub. No.: US 2005/0279264 A1
(43) Pub. Date: Dec. 22, 2005

(54) Garden tool

(75) Inventor: Michael R. Collins, Bedford, NH (US)

Correspondence Address: Bourque & Associates, P.A., Suite 301, 835 Hanover Street, Manchester, NH, 03104, US

(73) Assignee: Big Idea Group, Inc.

(21) Appl. No.: 10/874,106

(22) Filed: Jun. 22, 2004

(51) Int. Cl. A01C 23/02

(52) U.S. Cl. 111/7.1

(57) ABSTRACT

A garden tool for aerating, tilling, weeding, cultivating, and injecting a mixture of either water and air, or water, air, and fertilizer into the soil to the roots of plants has a shaft having a first end, second end, a hollow core, and an axis. A control handle is attached to the first end of the shaft and in fluid connection with the hollow core of the shaft. A trigger is mounted to the control handle, for varying a flow rate of water passing from a water source to the hollow core of the shaft. A coupler receives a water hose. A hand grip is adjustably mounted to the shaft and movable along the axis of the shaft, and includes a clamp mounted to the hand grip, for securing the hand grip to a location on the shaft. A triangular shaped head is operatively attached to the second end of the shaft and in fluid connection with the hollow core of the shaft. The triangular shaped head has a bottom surface on which teeth are mounted. The teeth have first surfaces that are convex shaped. A number of multiple water jet apertures are on the bottom surface of the triangular shaped head for discharging the mixture of water/air or water/air/fertilizer.

### TECHNICAL FIELD OF THE INVENTION

The present invention relates to a gardening tool and more particularly, relates to a garden tool for aerating, tilling, weeding, cultivating, and injecting fertilizer and water to roots of crops, flowers, trees, and the like.

### DESCRIPTION OF THE RELATED ART

Prior to planting seed or plants, such as crops, flowers, trees, and the like, it is beneficial to till, water, and fertilize the soil. Moreover, after planting and during the growth of crops, flowers, trees, and the like, the areas around the crops, flowers, trees, and the like may need to be weeded, watered, aerated or cultivated, and the roots of the crops, flowers, trees, and the like may need to be fertilized and watered.

Maintaining crops, flowers, trees, and the like is a tedious and arduous task. The most tiring aspect of maintaining such plants arises from the fact that one must repeatedly bend over and/or kneel for long periods of time, especially when weeding. This is compounded by the fact that planting and maintaining crops often occurs under the hot sun. In addition to the physical requirements for performing these tasks, various tools need to be available to perform these tasks. If one needs to rent or purchase these tools, it can be very expensive.

Another problem with the devices in the prior art is that they do not adequately mix water, air, and fertilizer, and more specifically, they work topically and do not adequately inject a mixture of water/air/fertilizer proximate the roots of crops, flowers, trees, and the like.

Another problem with the tools needed to plant and maintain crops, flowers, trees, and the like is that a separate tool may be required for each task. In addition to the costs associated with renting or purchasing these tools, considerable storage space is needed to store these tools.

Although there have been attempts to make a multipurpose garden tool, the devices in the prior art do not provide a sturdy and rigid device which is needed when tilling and weeding. In addition, these devices have working heads that tend to get caught up in the weeds during weeding because of their shape and configuration. Further, some of these devices have teeth that are not designed for maximum weeding and tilling. Finally, these devices have a single flow rate for water and are not capable of varying the flow rate to or spray rate discharged from the head.

Therefore, there is a need for a rigid and sturdy garden tool for performing multiple gardening tasks that has a unique head that reduces snagging or catching on weeds, and uniquely shaped teeth that facilitate tilling, aerating and cultivating. There is also a need for a garden tool that can inject a mixture of water/air or water/air/fertilizer more directly to the roots of crops, flowers, trees, and the like. Moreover, there is a need for a garden tool that can vary or control the flow of water being discharged from the unique head.

### SUMMARY OF THE INVENTION

The present invention is a rigid and sturdy multipurpose gardening tool for aerating, tilling, weeding, cultivating, and injecting fertilizer and water to roots of crops, flowers, trees, and the like. The garden tool has a shaft that has a hollow core for conducting water.

A control handle is attached to a first end of the shaft, and a triangular shaped head is attached to the second or opposite end of the shaft. The control handle may vary or control the water flow or flow rate through the hollow core shaft of the garden tool to the unique triangular shaped head. Specifically, a trigger on the control handle is used to vary or control the water flow.

The triangular shaped head has a rearward pointing heel or point, which facilitates pulling the triangular shaped head back through weeds, grass, brush, bushes, trees, flowers, and the like when in use. Because of its shape, the triangular shaped head also reduces snagging or catching on weeds, grass, bushes, trees, flowers, and the like. The triangular shaped head has a bottom surface with teeth extending therefrom that are designed to facilitate tilling of the soil and weeding. The triangular head also has multiple water jet apertures on the bottom surface that provide multiple different spray patterns and mixtures of water/air or water/air/fertilizer being discharged. The teeth, water jet apertures, and internal cavity of the triangular shaped head provide optimum mixing of water/air, water/fertilizer or water/air/fertilizer, and optimal injection of the mixture nearly directly to the roots of crops, flowers, trees, and the like.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings wherein:

FIG. 1 is a side view of a garden tool according to the preferred embodiment of the present invention;

FIG. 2 is a perspective view of a control handle of the garden tool according to the present invention;

FIG. 3 is a side view of an adjustable hand grip according to one feature of the garden tool according to the present invention;

FIG. 4 is a side view of a triangular shaped head of the garden tool according to the present invention; and

FIG. 5 is a bottom view of the triangular shaped head of the garden tool according to the present invention.

### DETAILED DESCRIPTION

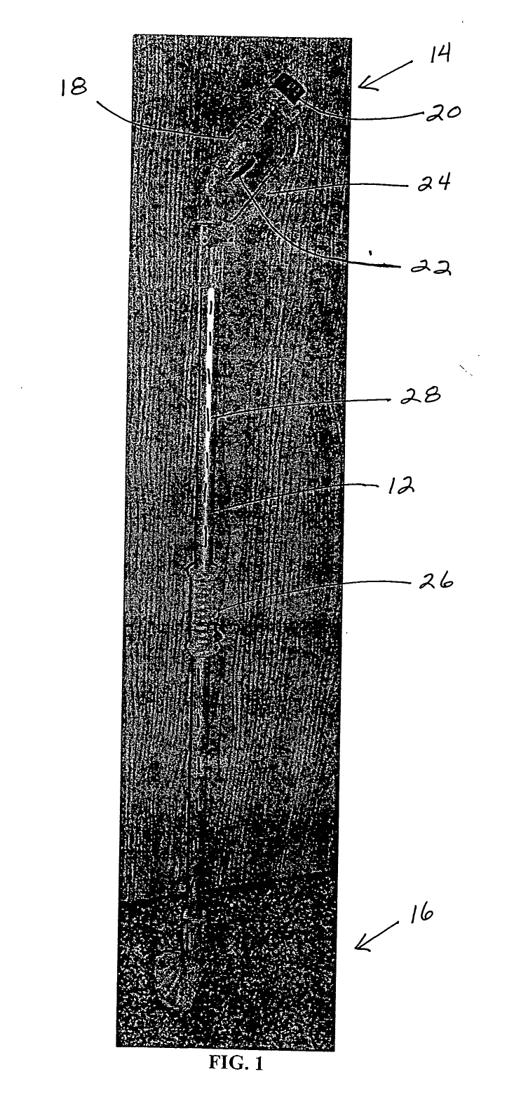

The present invention is a garden tool 10 for aerating, tilling the soil, weeding, cultivating, and injecting a mixture of either water/air or water/air/fertilizer onto and into the soil to the roots of crops, flowers, trees, and the like (hereinafter collectively “plants”). The garden tool, FIG. 1, has a control handle 18 operatively attached to a first end 14 of a shaft 12 and a triangular shaped head 34 operatively attached to a second end 16 of the shaft 12. A water source is connected to the control handle 18 and water from the water source is passed from the water source to the control handle 18, through hollow shaft 12, and into and out of the triangular shaped head 34.

In an alternative embodiment, an in-line fertilizing device such as is well known in the art may be operatively mounted between the water source and the control handle 18. The in-line fertilizing device adds fertilizer or herbicide to the incoming water changing the mixture from water/air to water/air/fertilizer. The triangular shaped head 34 will then spray the mixture of water/air/fertilizer onto and into the soil to the roots of the plants.

The shaft 12 is, preferably, a single piece or unitary structure between the first end 14 and the second end 16. The shaft is, preferably, made from aluminum and not adjustable in length. In alternative embodiments, the shaft 12 is made from other sturdy and lightweight materials such as plastic, metal or synthetic material. The shaft 12 is rigid and sturdy, which is beneficial when performing the previously described tasks. The shaft 12 has a hollow core for passing water through from the water source to the triangular shaped head 34. If the shaft 12 is made from metal, it may be extruded.

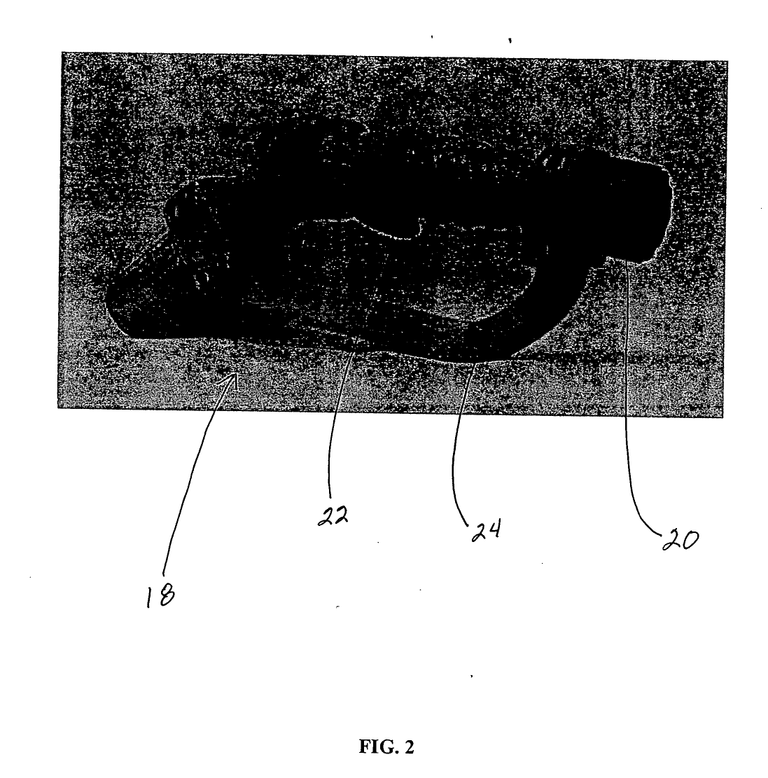

The control handle 18 is operatively connected to and in fluid connection with the shaft 12. The control handle 18 has a coupler 20, FIG. 2, with internal threads for receiving external threads of an end of a water hose in fluid connection with the water source. Specifically, the threaded end of the water hose screws into the coupler 20.

The control handle 18 has a trigger 22 that is used to vary and control the flow and flow rate of the water passing from the water hose to the hollow core of the shaft 12 and ultimately the flow and flow rate discharged from the triangular shaped head 34. The trigger 22 may stop the water flowing from the water hose to the hollow core of the shaft 12 when placed in an “off” position. If the water source is supplying water to the water hose connected to the garden tool 10, the trigger 22 may allow water to flow to the hollow core of the shaft 12 in an “on” position. Moreover, varying the pressure on and therefore the position of the trigger 22 will vary or adjust the flow rate of the water passing from the water hose to the hollow core of the shaft 12. This is significant because it allows for controlled watering, thus reducing excessive and insufficient watering. As such, the trigger 22 varies or adjusts the injection and spray rate of the water/air or water/air/fertilizer mixture exiting the triangular shaped head 34 onto and into the soil and to the roots of the plants. The flow rate may be increased or decreased depending on, for example, the size and condition of the plant, the type and condition of the soil surrounding the roots of the plant, and the previous rainfall in the area. In the preferred embodiment, the trigger 22 may also be locked in an “on” position or an “off” position.

The control handle 18 also has a guard 24 that adds structural stability and reduces the probability of accidental activation of the trigger 22. The guard 24 also protects the user's hand in heavy brush areas.

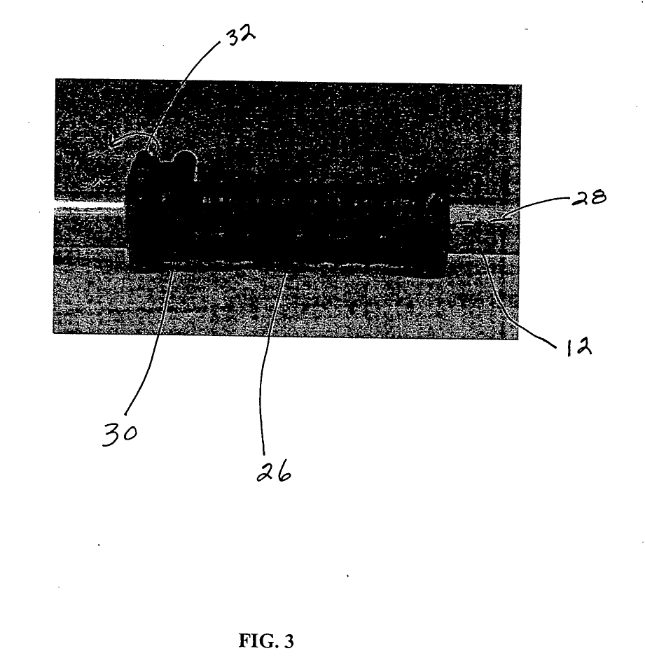

A hand grip 26 FIGS. 1 and 3 is adjustably mounted to the shaft 12 of the garden tool 10. The shaft 12 has an axis 28, and the hand grip 26 moves axially along the axis 28. The hand grip 26 may be secured to a position along the axis 28 by a clamp or other similar device 30. The clamp 30 is pivotably mounted to the hand grip 26. In FIG. 3, the clamp 30 is shown unsecured to the shaft 12, and the hand grip 26 is free to move axially along the axis 28 of the shaft 12. The clamp 30 may be moved to a secured position as shown by phantom lines in FIG. 3 by pivoting the clamp 30 about its axis to the secured position. When the clamp 30 is pivoted to the secured position, a boss 32 on the clamp 30 applies pressure between the shaft 12 and the clamp 30 fixed to the shaft 12, thereby restricting the movement of the hand grip 26 along the axis 28 of the shaft 12. To adjust the hand grip 26, the clamp 30 is placed in the unsecured position, and the hand grip 26 is moved axially along the axis 28 until a desired position is obtained. Once the hand grip 26 is placed in the desired position, the clamp 30 is placed in the secured position.

The second end 16 of the shaft 12 has the triangular shaped head 34 operatively connected to and in fluid connection with the hollow core of the shaft 12, FIG. 1. The rigid shaft 12 and the sturdy triangular shaped head 34 provide for a very strong and durable garden tool 10.

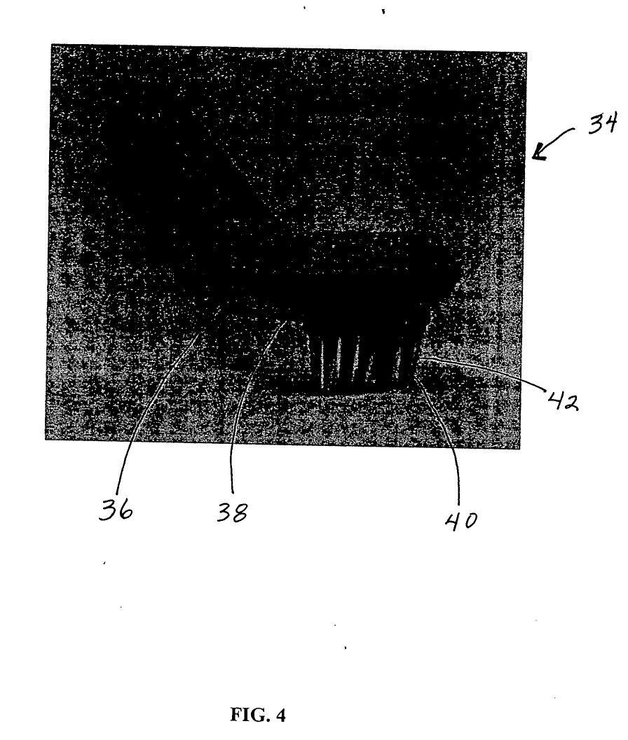

The triangular shaped head 34, FIG. 4 serves several important functions. First, the shape of the triangular shaped head 34 reduces snagging or catching on weeds, grass, brush, bushes, trees, flowers, and the like. Second, a rearwards pointing tip or heel 36 of the triangular shaped head 34 facilitates pulling the triangular shaped head 34 back through weeds, grass, bushes, trees, flowers, and the like when in use. Specifically, the heel 36 is preferably rounded to avoid snagging and catching on weeds, grass, brush, bushes, trees, flowers, and the like.

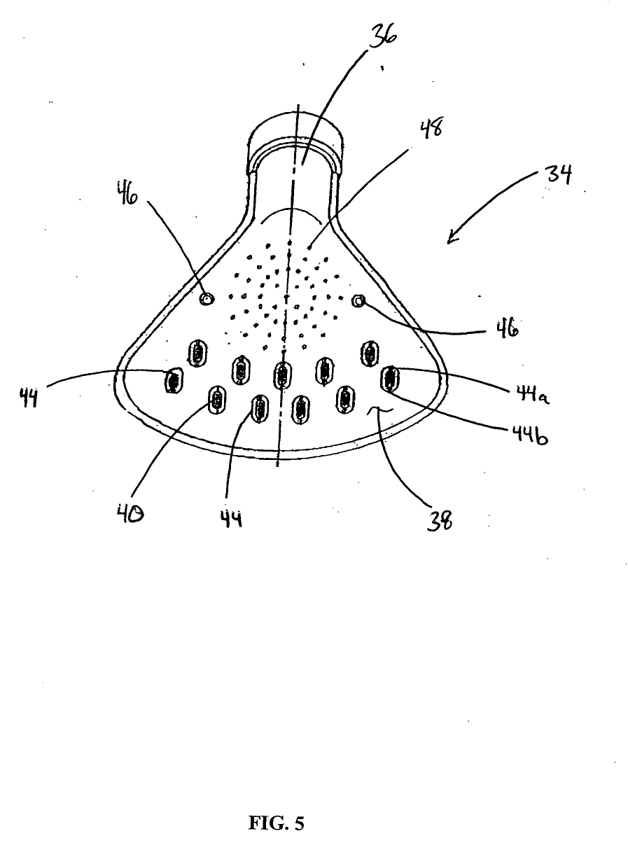

The triangular shaped head 34 has a bottom surface 38, FIGS. 4 and 5. Teeth 40 extend from the bottom surface 38. The teeth 40 are used to till and uncompact the soil, create holes in the soil for water to seep through, weed, and cultivate. In the preferred embodiment, the teeth 40 are a single forged unit. The teeth 40 have first or forward pointing surfaces 42 that are substantially convex shaped. The convex shape of the teeth 40 makes it easier to puncture the soil and provides effective and efficient tilling of the soil. Further, the teeth 40 have a length, width, and depth. Specifically, the teeth 40 have relatively narrow widths and relatively large depths. The narrow widths of the forward pointing surfaces 42 of the teeth 40 and the arrangement of the teeth 40 in a triangular pattern make it easier to pull through the soil and reduces snagging or catching on weeds. Further, the teeth 40 have relatively large depths with respect to the widths. The relatively large depths behind the forward pointing surfaces 42 of the teeth 40 maximize strength and durability. The convex shaped forward pointing teeth 40, relatively narrow widths of the teeth 40, and the relatively large depths of the teeth 40 maximize strength and durability, improve penetration of the soil, and reduce snagging or catching on weeds.

There are multiple water jet apertures 44, 46, 48 on the bottom surface 38 of the triangular shaped head 34 as shown in FIG. 5. The water jet apertures 44, 46, 48 are designed to produce a water/air or water/air/fertilizer mixture spray, which is beneficial when aerating. The water jet apertures 44, 46, 48 are shaped such that air readily mixes with the water sprayed from the triangular shaped head 34 through the water jet apertures 44, 46, 48. Specifically, the triangular shaped head 34 has an internal cavity that is not solid, thereby causing air to mix with the water being received from the hollow core of the shaft 12.

A first set of the water jet apertures 44 is located proximate generally each of the teeth 40 on the bottom surface 38 of the triangular shaped head 34. In the preferred embodiment, the first set of water jet apertures 44 generally completely surround each of the teeth 40. In other alternative embodiments, the first set of water jet apertures 44 are holes proximate the teeth 40. Other effective hole patterns are also contemplated by this invention. In use, the teeth 40 are used to till, make holes, or make channels in the soil or ground surface, and the first set of water jet apertures 44 spray a water/air or water/air/fertilizer mixture into the tilled area, holes, or channels created by the teeth 40 for optimal aerating, watering, and fertilizing of the roots of the plants. The first set of water jet apertures 44 also sprays the teeth 40 to remove any accumulating soil, weeds, etc.

A second set of the water jet apertures 46 is also located on the bottom surface 38 of the triangular shaped head 34. The second set of water jet apertures 46 spray a water/air or water/air/fertilizer mixture. However, unlike the first set of water jet apertures 44, the second set of apertures 46 are not proximate the teeth 40. The second set of water jet apertures 46 has wider openings than openings for the first set of water jet apertures 44, thereby providing more water flow. There are, preferably, two of the second set of apertures 46 located between the heel 36 and the teeth 40.

A third set of the water jet apertures 48 is located between the heel 36 and the teeth 40 of the triangular shaped head 34. In the preferred embodiment, the third set of water jet apertures include a number of generally smaller apertures having a generally circular pattern. The third set of water jet apertures 48 provides a fine spray of water/air or water/air/fertilizer mixture. Openings for the third set of water jet apertures 48 are narrower than the openings of the first and second water jet apertures 44, 46 and provide a fine spray discharge.

It is important to note that the flow rates or water output from the first set of water jet apertures 44, the second set of water jet apertures 46, and the third set of water jet apertures 48 are not the same versus the other. This is significant because the various flow rates or water output provides different water/air or water/air/fertilizer mixture.

Accordingly, the present invention provides a garden tool that aerates, tills the soil, weeds, cultivates, and injects a mixture of either water/air or water/air/fertilizer onto and into the soil to the roots of plants. The teeth 40 aerate and till the soil or ground surface, and create holes and channels in the soil or ground surface, thus allowing the multiple water jet apertures 44, 46, 48 to spray the water/air or water/air/fertilizer mixture into the aerated and tilled soil and into the holes and channels created by the times 40, for optimum watering or fertilizing, respectively, of the roots of plants.

As mentioned above, the present invention is not intended to be limited to a system or method which must satisfy one or more of any stated or implied object or feature of the invention and is not be limited to the preferred, exemplary, or primary embodiment(s) described herein. Modifications and substitutions by one of ordinary skill in the art are considered to be within the scope of the present invention, which is not to be limited except by the following claims.

1. A garden tool comprising:
a shaft having a first end, a second end, a hollow core, and a longitudinal axis, wherein the shaft is one piece between the first end and the second end;
a control handle, operatively attached to the first end of the shaft and in fluid connection with the hollow core of the shaft, said control handle including a coupler for connecting to a source of water;
a trigger operatively mounted to the control handle, for varying a flow rate of water passing from said water source to the hollow core of the shaft;
a triangular shaped head, operatively attached to the second end of the shaft, in fluid connection with the hollow core of the shaft, and having a bottom surface;
teeth operatively mounted to and extending from the bottom surface of the triangular shaped head, and the teeth having first surfaces that are convex shaped; and
at least a first plurality of apertures on the bottom surface of the triangular shaped head, for spraying a mixture of either water and air or water and air and fertilizer.

2. The garden tool according to claim 1, further including a clamping device, mounted to the hand grip, for releasably securing the hand grip to a user selectable location on the shaft.

3. The garden tool according to claim 1, wherein the convex shaped teeth have widths and depths, and the widths are larger than the depths.

4. The garden tool according to claim 1, wherein the triangular shaped head includes three different pluralities of apertures, and wherein each of said three different pluralities of apertures has a unique spray rate or pattern.

5. The garden tool according to claim 1, wherein the variable trigger controls the flow rate through the garden tool and exiting the apertures.

6. The garden tool according to claim 5, wherein the variable trigger has a locking mechanism, for locking the variable trigger in either an “on” position or an “off” position.

7. The garden tool according to claim 1, wherein the triangular shaped head has a rearwards pointing heel.

8. The garden tool according to claim 1, wherein the teeth are a single forged unit.

9. The garden tool according to claim 8, further including a first set of apertures, wherein each of the teeth are surrounded by one of the first set of apertures.

10. The garden tool according to claim 1, further including a hand grip, adjustably mounted to the shaft and movable along the longitudinal axis of the shaft.

11. The garden tool according to claim 1, further including an in-line fertilizing device disposed between said water source and said coupler, for adding fertilizer or herbicide to the mixture of air and water.

12. The garden tool according to claim 1, further including a guard operatively attached to the control handle.

13. The garden tool according to claim 1, wherein said coupler includes an internally threaded region for mating with an externally threaded region on a water hose, and wherein said water hose is fluidly coupled to said water source.

14. A multipurpose garden tool comprising:
a control handle having a coupler in fluid connection with a water hose;
a trigger operatively connected to the coupler, for adjustably controlling a flow rate of water received from said water hose;
a shaft having a hollow core, a first end operatively connected to and in fluid connection with the coupler, and a second end, and wherein the shaft is a unitary structure from the first end to the second end;
a triangular shaped head operatively attached to and in fluid connection with a second end of the shaft;
wherein the triangular shaped head has a contoured heel portion and a bottom surface having a plurality of teeth operatively attached to it and extending therefrom;
a first set of apertures on the bottom surface of said triangular shaped head and generally surrounding each of the plurality of teeth;
a second set of apertures located on the bottom surface of the triangular shaped head; and
a third set of apertures located on the bottom surface of the triangular shaped head, wherein the third set of apertures are arranged in a generally circular configuration.

15. The multipurpose garden tool according to claim 14, further including a hand grip adjustably mounted to the shaft, and wherein the shaft has a longitudinal axis and the hand grip is movable along the longitudinal axis.

16. The multipurpose garden tool according to claim 14, wherein the variable trigger has a locking mechanism, for locking the variable trigger in either an “on” position or an “off” position.

17. The multipurpose garden tool according to claim 15, wherein the plurality of teeth have front surfaces that have a generally convex shape.

18. The multipurpose garden tool according to claim 14, further including an in-line fertilizing device disposed between the water hose and the apparatus.

19. The multipurpose garden tool according to claim 18, further including a guard operatively attached to the control handle.

20. The multipurpose garden tool according to claim 19, wherein the water hose includes an externally threaded region and the coupler has an internally threaded region, and wherein the water hose is fluidly coupled to said coupler.
